(19) United States
(12) Patent Application Publication
(10) Pub. No.: US 2025/0308734 A1
(43) Pub. Date: Oct. 2, 2025

(54) MULTILAYER VARISTOR AND METHOD OF PRODUCING SAME

(71) Applicant: Panasonic Intellectual Property Management Co., Ltd., Osaka (JP)

(72) Inventors: NAOKI MUTOU, Hokkaido (JP); SATOSHI KAWAMURA, Hokkaido (JP); YASUTAKA OKAMOTO, Hokkaido (JP); DAIKI NAKAYAMA, Hokkaido (JP)

(21) Appl. No.: 19/040,918

(22) Filed: Jan. 30, 2025

(30) Foreign Application Priority Data
Mar. 27, 2024 (JP) 2024-052374

(51) Int. Cl. H01C 7/12

(52) U.S. Cl. CPC H01C 7/12

(57) ABSTRACT

A multilayer varistor includes a ceramic body, an internal electrode disposed inside the ceramic body, a high-resistance layer disposed on a surface of the ceramic body, and an external electrode disposed on a part of a surface of the high-resistance layer and connected to the internal electrode. The ceramic body contains zinc oxide and praseodymium oxide, and does not contain bismuth oxide. The high-resistance layer contains Zn₂SiO₄.

### TECHNICAL FIELD

The present disclosure relates to a multilayer varistor and a method of producing the multilayer varistor, and particularly to a multilayer varistor including a ceramic body and a high-resistance layer and to a method of manufacturing the multilayer varistor.

### BACKGROUND ART

In various electronics, electronic devices, and the like, multilayer varistors are used for the purpose of, for example, protecting the various electronics, electronic devices, and the like from abnormal voltages due to a lightning surge, static electricity, and the like, and preventing malfunction of the electronic, electronic devices, and the like due to a noise generated in a circuit.

In a multilayer varistor, an SiO₂ layer is formed as a high-resistance layer on a surface of a ceramic body for the purpose of improving plating resistance and ensuring moisture resistance reliability.

Japanese Patent Laid-Open Publication No. 05-251210 discloses a conductive chip-type ceramic element which is a multilayer varistor. The ceramic element includes a conductive chip-shaped ceramic body, a terminal electrode including a plating layer and a fired electrode layer formed by firing a conductive paste including metal powder and inorganic binder, and an insulating inorganic material layer having a melting point or a softening point higher than a firing temperature at the forming of the fired electrode. The insulating inorganic material layer is composed of SiO₂ or of 50% by weight or more of SiO₂ with the balance of oxide, such as Al₂O₃.

Japanese Patent Laid-Open Publication No. 05-251210 indicates that the insulating inorganic material layer reacts with the inorganic binder, melts to be absorbed by the fired electrode layer, and disappears when the fired electrode layer is formed.

In the conventional multilayer varistor disclosed in Japanese Patent Laid-Open Publication No. 05-251210, the insulating inorganic material layer becomes uneven due to the reaction and melting of the insulating inorganic material layer as described above, and may degrade insulation due to reaction between an exposed ceramic body and plating solution. Not only the insulating inorganic material layer directly below an external electrode but also the insulating inorganic material layer on a periphery of the external electrode disappears, and degrades sealing properties between the ceramic body and the external electrode, accordingly allowing moisture to infiltrate into the multilayer varistor. The conventional multilayer varistor has a disadvantage that moisture resistance reliability is easily decreased due to these factors.

### SUMMARY OF INVENTION

In order to address the above disadvantage, moisture resistance reliability of a multilayer varistor may be enhanced by replacing the SiO₂ layer as a high-resistance layer with a ceramic crystal layer, such as a Zn₂SiO₄ layer, having higher resistance and a higher melting point. In a Bi-based varistor including a ceramic body mainly containing ZnO and containing bismuth (Bi) oxide, heat treatment at a temperature of 800° C. or higher causes ZnO in the ceramic body and SiO₂ in a high-resistance layer to react with each other to generate Zn₂SiO₄ by an action of the Bi oxide in the ceramic body, thereby forming a high-resistance layer.

However, in a Pr-based varistor including a ceramic body mainly containing ZnO and containing praseodymium (Pr) oxide, the above-described forming method cannot be used due to addition of a Bi oxide to the ceramic body greatly affecting the conductive mechanism particularly on grain boundaries of the ceramic body and degrading basic performance of the varistor. Therefore, a Zn₂SiO₄ layer as a high-resistance layer cannot be formed in a Pr-based varistor.

A multilayer varistor according to an aspect of the present disclosure includes a ceramic body, an internal electrode disposed inside the ceramic body, a high-resistance layer disposed on a surface of the ceramic body, and an external electrode disposed on a part of a surface of the high-resistance layer and connected to the internal electrode. The ceramic body contains zinc oxide and praseodymium oxide, and does not contain bismuth oxide. The high-resistance layer contains Zn₂SiO₄.

In a method of producing a multilayer varistor according to an aspect of the present disclosure, a ceramic body and an internal electrode disposed inside the ceramic body are prepared. A high-resistance layer is formed on a surface of the ceramic body. An external electrode is formed on a part of a surface of the high-resistance layer. The external electrode is connected to the internal electrode. The ceramic body contains zinc oxide and praseodymium oxide, and does not contain bismuth oxide. The high-resistance layer contains Zn₂SiO₄.

The multilayer varistor of the present disclosure has high moisture resistance reliability due to a Zn₂SiO₄-containing high-resistance layer on a surface of a Pr-containing body. The method of producing a multilayer varistor of the present disclosure provides a multilayer varistor with high moisture resistance reliability due to a Zn₂SiO₄-containing high-resistance layer on a surface of a Pr-containing body simply and reliably produced.

### BRIEF DESCRIPTION OF DRAWINGS

FIG. 1 is a schematic cross-sectional view of a multilayer varistor according to a first exemplary embodiment of the present disclosure.

FIG. 2 is a schematic cross-sectional view of a multilayer varistor according to a second exemplary embodiment of the present disclosure.

### DESCRIPTION OF EMBODIMENT

### 1. Outline

An outline of multilayer varistor 1 will be described below with reference to drawings. The drawings are schematic views, and ratios of sizes and thicknesses of constituent elements in the drawings do not necessarily reflect actual dimensional ratios.

Inventors have found, through intensive studies, that the above problem can be solved through various studies on a method of forming a high-resistance layer in a multilayer varistor, and have completed a multilayer varistor according to the present disclosure.

Multilayer varistor 1 according to an exemplary embodiment includes ceramic body 11, internal electrode 12 disposed inside ceramic body 11, high-resistance layer 13 disposed on a surface of ceramic body 11, and external electrode 14 disposed on a part of a surface of high-resistance layer 13 and connected to internal electrode 12. Ceramic body 11 contains zinc oxide and praseodymium oxide, and does not contain bismuth oxide. High-resistance layer 13 contains Zn₂SiO₄.

Multilayer varistor 1 of the present embodiment has moisture resistance reliability enhanced due to a Zn₂SiO₄-containing high-resistance layer on a surface of a Pr-containing body. The “moisture resistance reliability” refers to excellence in moisture resistance of multilayer varistors as evaluated through a pressure cooker bias test (PCBT) (conditions: 121° C., 100% RH, 2 atm, DC application at a voltage value of 85% of varistor voltage). Moisture resistance reliability of a multilayer varistor is evaluated as good when a decrease (ΔV_{1mA}) in varistor voltage (V_{1mA}) is 10% or less or when a decrease (ΔV_{1μA}) in varistor voltage (V_{1μA}) indicating an increase in leakage current is 50% or less.

In a case where high-resistance layer 13 contacts ceramic body 11, multilayer varistor 1 of the present embodiment eliminates influence of diffusion of a Bi oxide or the like when ceramic body 11 is made of material not containing Bi oxide, and high-resistance layer 13 does not contain Bi oxide. This configuration forms Zn₂SiO₄-containing high-resistance layer 13 by a method that does not require an action of Bi oxide for layer formation. Intermediate layer 15 between ceramic body 11 and high-resistance layer 13 of multilayer varistor 1 suppresses influence of Bi oxide diffusing from high-resistance layer 13 to ceramic body 11 even when high-resistance layer 13 contains Bi oxide. Accordingly, it is possible to form Zn₂SiO₄-containing high-resistance layer 13 by both a method that does not require an action of Bi oxide for layer formation and a method that requires an action of Bi oxide. This enhances moisture resistance reliability of multilayer varistor 1.

### 2. Detail

### Multilayer Varistor

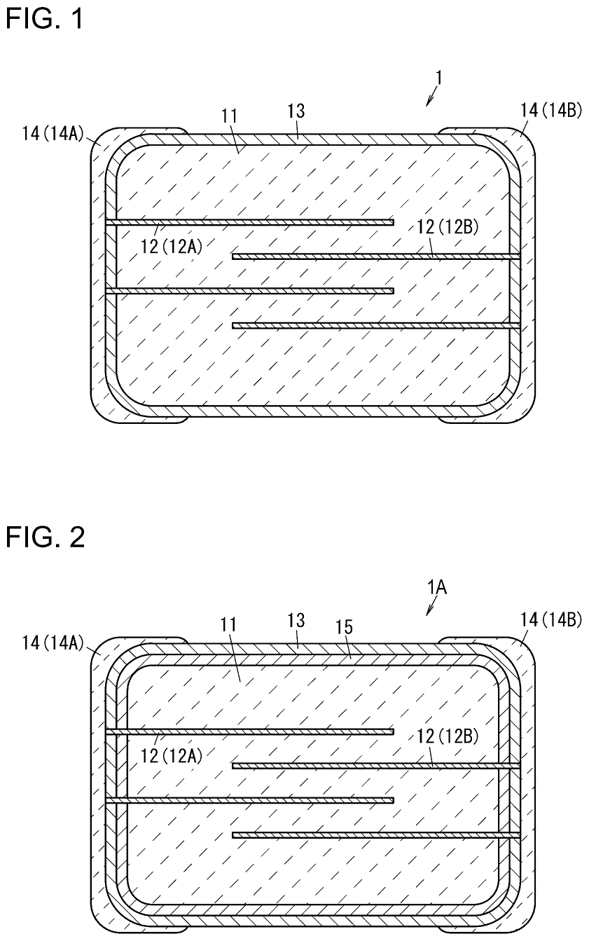

Multilayer varistor 1 will be detail below with reference to FIG. 1 and FIG. 2.

Multilayer varistor 1 includes at least one pair of internal electrodes 12 and at least one pair of external electrodes 14. In multilayer varistor 1 shown in FIG. 1 and FIG. 2, the number of internal electrodes 12 is four (two pairs), and the number of external electrodes 14 is two (one pair). Internal electrodes 12 include, for example, two first internal electrodes 12A and two second internal electrodes 12B. External electrodes 14 include, for example, first external electrode 14A disposed on one end surface of ceramic body 11 and second external electrode 14B disposed on the other end surface of ceramic body 11. First internal electrode 12A is connected to first external electrode 14A, and second internal electrode 12B is connected to second external electrode 14B. Specifically, the internal electrodes are electrically connected to the external electrodes. In multilayer varistor 1, one of first external electrode 14A and second external electrode 14B serves as an electrode on the high potential side, and the other serves as an electrode on the low potential side.

In the present embodiment, the phrase “disposed on a surface” means that the disposed component is placed directly or indirectly on the surface, that is, includes not only contacting the surface but also providing a distance from the surface or via another layer.

### First Exemplary Embodiment

FIG. 1 illustrates multilayer varistor 1 according to a first exemplary embodiment. Multilayer varistor 1 according to the first embodiment includes ceramic body 11, internal electrode 12, high-resistance layer 13 contacting ceramic body 11, and external electrode 14. Ceramic body 11 contains zinc oxide and praseodymium oxide, and does not contain bismuth oxide. High-resistance layer 13 contains Zn₂SiO₄ and does not contain bismuth oxide.

In multilayer varistor 1 according to the first embodiment, Zn₂SiO₄-containing high-resistance layer 13 is formed even if high-resistance layer 13 contacts ceramic body 11, and enhances moisture resistance reliability of the varistor.

### Ceramic Body

Ceramic body 11 is made of, e.g., semiconductor ceramic component having non-linear resistance characteristics. Ceramic body 11 mainly contains zinc oxide, such as ZnO as main component and further contains praseodymium oxide, such as Pr₂O₃₁ or Pr₆O₁₁, as additive. Ceramic body 11 may further contain Co₂O₃, MnO₂, Sb₂O₃, CaCO₃, or Cr₂O₃ as additive. The zinc oxide as the main component is sintered and forms a solid solution with a part of the additives, such as the praseodymium oxide in the semiconductor ceramic component, and the remainder of the additive precipitates at grain boundaries, thereby providing ceramic body 11.

### Internal Electrode

Internal electrode 12 is disposed inside ceramic body 11. Internal electrode 12 contains, for example, metal component, such as Ag, Pd, PdAg, or PtAg. Ceramic body 11 having internal electrode 12 inside thereof may formed, for example, by stacking ceramic sheets onto which an internal electrode paste containing the metal component described above is applied, and firing the stacked sheets.

### High-Resistance Layer

High-resistance layer 13 contacts ceramic body 11. That is, high-resistance layer 13 is placed directly on ceramic body 11. In addition, high-resistance layer 13 is disposed on a surface of ceramic body 11. High-resistance layer 13 may cover a part of the surface of ceramic body 11, but may preferably cover the entire surface of ceramic body 11.

High-resistance layer 13 contains Zn₂SiO₄ and does not contain bismuth oxide.

High-resistance layer 13 containing Zn₂SiO₄ and not containing Bi oxide may be formed by a method that does not require an action of Bi oxide for layer formation, for example, by atomic layer deposition (ALD).

An average thickness of high-resistance layer 13 is, e.g., 0.01 μm or more and 5.0 μm or less, and is preferably 0.1 μm or more and 1.5 μm or less. The “average thickness” means an arithmetic average value of thicknesses of the layer measured at multiple points (for example, any 10 points) of high-resistance layer 13.

### External Electrode

External electrode 14 is disposed on a part of a surface of high-resistance layer 13 to cover a part of high-resistance layer 13, and is connected to internal electrode 12 electrically.

External electrode 14 contains metal component, such as Ag, AgPd, or AgPt, and glass component, such as Bi₂O₃, SiO₂, or B₂O₃. The main component of external electrode 14 is preferably metal, and is more preferably Ag.

External electrode 14 may have a single layer structure (external electrode 14A and external electrode 14B) or may have a multilayer structure having multiple layers.

External electrode 14 is formed by applying an external electrode paste containing the metal component onto a part of a surface of high-resistance layer 13 and firing them.

### Plated Electrode

A plated electrode is disposed at least a part of a surface of external electrode 14, that is, disposed so as to cover at least a part of external electrode 14. The plated electrode includes, e.g., an Ni electrode disposed so as to cover at least the part of external electrode 14 and an Sn electrode disposed so as to cover at least a part of the Ni electrode.

### Second Exemplary Embodiment

FIG. 2 illustrates multilayer varistor 1A according to a second exemplary embodiment.

Multilayer varistor 1A according to the second embodiment includes intermediate layer 15 between ceramic body 11 and high-resistance layer 13 in addition to ceramic body 11, internal electrode 12, high-resistance layer 13, and external electrode 14. Ceramic body 11 contains zinc oxide and praseodymium oxide, and does not contain bismuth oxide. High-resistance layer 13 contains Zn₂SiO₄ and contains bismuth oxide.

In multilayer varistor 1A according to the second embodiment, Zn₂SiO₄-containing high-resistance layer 13 may be formed by providing intermediate layer 15, and enhances moisture resistance reliability.

Ceramic body 11, internal electrode 12, external electrode 14, and the plated electrode of multilayer varistor 1A according to the second embodiment are identical to those of multilayer varistor 1 according to the first embodiment.

### Intermediate Layer

Intermediate layer 15 is disposed between ceramic body 11 and high-resistance layer 13. Intermediate layer 15 suppresses influence of diffusion of Bi oxide from high-resistance layer 13 to ceramic body 11 on performance of multilayer varistor 1A. This configuration allows a high-resistance layer containing Zn₂SiO₄ to be formed both by a method that requires an action of Bi oxide and by a method that does not require an action of Bi oxide. Intermediate layer 15 may be one layer or two or more layers.

Examples of a layer constituting intermediate layer 15 as a single layer structure include an SiO₂ layer containing SiO₂ and an Al₂O₃ layer containing Al₂O₃. Examples of a layer constituting intermediate layer 15 as a two-layer structure of two layers contacting each other and stacked include an SiO₂ layer/Al₂O₃ layer structure and an Al₂O₃ layer/SiO₂ layer structure (ceramic body 11 side/high-resistance layer 13 side). That is, in the present embodiment, an SiO₂ layer may face and contact ceramic body 11, and an Al₂O₃ layer may face and contact high-resistance layer 13. Alternatively, an Al₂O₃ layer may face and contact ceramic body 11, and an SiO₂ layer may face contact high-resistance layer 13. The Al₂O₃ layer is preferable due to suppressing diffusion of a Bi oxide from high-resistance layer 13 to ceramic body 11 and to facilitating reaction to produce a Zn₂SiO₄ layer in high-resistance layer 13. The SiO₂ layer is preferable due to suppressing diffusion of Al₂O₃ to ceramic body 11 and to serving as an auxiliary agent for bonding ceramic body 11 to Zn₂SiO₄-containing high-resistance layer 13 or Al₂O₃ intermediate layer 15 to enhance fixing force. From the viewpoint of enhancing these effects, intermediate layer 15 may preferably have a two-layer structure of SiO₂ layer/Al₂O₃ layer (ceramic body 11 side/high-resistance layer 13 side). That is, according to the present embodiment, the SiO₂ layer faces and contacts ceramic body 11, and the Al₂O₃ layer faces and contacts high-resistance layer 13. Multilayer varistor 1A thus more preferably has a layered structure in which ceramic body 11, the SiO₂ layer, the Al₂O₃ layer, and a Zn₂SiO₄ layer are stacked in this order.

As a method of forming intermediate layer 15, any method that does not require an action of Bi oxide for layer formation may be used, and examples thereof include a method in which precursor slurry containing a precursor substance for intermediate layer 15 is applied, followed by heat treatment to dehydrate and cure same, and a method using atomic layer deposition (ALD).

The average thickness of intermediate layer 15 is, for example, 0.1 μm or more and 10 μm or less and is preferably 0.5 μm or more and 5 μm or less.

### High-Resistance Layer

High-resistance layer 13 contains Zn₂SiO₄ and does not contain bismuth oxide. Intermediate layer 15 disposed between ceramic body 11 and high-resistance layer 13 in multilayer varistor 1A according to the second embodiment suppresses influence of diffusion of the Bi oxide to the ceramic body 11 even if high-resistance layer 13 contains Bi oxide, and allows high-resistance layer 13 containing Zn₂SiO₄ to be formed by a method that requires an action of Bi oxide. High-resistance layer 13 may be one layer or plural layers but is usually one layer.

Examples of a method for forming Zn₂SiO₄-containing high-resistance layer 13 include a method in which a mixture of ZnO, SiO₂, and Bi₂O₃ is applied onto a surface of intermediate layer 15, followed by heat treatment, and a method in which a ZnO layer, an SiO₂ layer, and a Bi₂O₃ layer are layered by ALD, followed by heat treatment.

An average thickness of high-resistance layer 13 is, for example, 0.1 μm or more and 2.0 μm or less and is preferably 0.5 μm or more and 1.5 μm or less.

Method of Producing Multilayer Varistor

### First Exemplary Embodiment

A method of producing multilayer varistor 1 according to the first embodiment includes a first step, a second step, and a third step described below. In the production method of the first embodiment, high-resistance layer 13 contains Zn₂SiO₄ and does not contain bismuth oxide.

### First Step

In the first step, ceramic body 11 containing zinc oxide and praseodymium oxide and not containing bismuth oxide and having internal electrode 12 disposed inside ceramic body 11 is prepared.

Ceramic body 11 may be produced in the first step, and ceramic body 11 having internal electrode 12 inside thereof may be produced by applying an internal electrode paste onto a ceramic sheet produced with slurry containing zinc oxide and praseodymium oxide, and laminating, pressing, and cutting the ceramic sheet, followed by binder removal and firing, for example. The slurry may be prepared by, for example, mixing ZnO as main material, Pr₂O₃, Pr₆O₁₁, or the like as additional material, and binder.

As the internal electrode paste, an Ag paste, a Pd paste, a Pt paste, a PdAg paste, a PtAg paste, or the like may be used, for example.

The temperature at which the binder is removed is, for example, 300° C. or higher and 500° C. or lower. The firing temperature may be appropriately adjusted according to the configuration and composition of ceramic body 11 to be obtained, and is, for example, 800° C. or higher and 1300° C. or lower.

### Second Step

In the second step, high-resistance layer 13 containing Zn₂SiO₄ is formed on a surface of ceramic body 11 prepared in the first step.

In the second step, Zn₂SiO₄-containing high-resistance layer 13 is formed preferably by atomic layer deposition (ALD). High-resistance layer 13 is formed by atomic layer deposition allows multilayer varistor 1 with enhanced moisture resistance reliability to be produced more simply and reliably.

ALD is a method of forming each layer formed from atomic layer deposit by introducing a gaseous precursor into a surface on which a layer is formed, subjecting same to, for example, oxidation through irradiation with O₂ plasma, Ar plasma, or the like or with H₂O or the like, and repeating these steps. Zn₂SiO₄-containing high-resistance layer 13 is formed by, for example, firstly forming, on a surface of ceramic body 11, auxiliary layers to form a Zn₂SiO₄ layer, two Zn-containing layers and a Si-containing layer between the Zn-containing layers, followed by O₂ plasma irradiation or the like. When the Si-containing layer is formed, an Si-containing layer is formed using, as a precursor, tetra (1-methoxy-2-methyl-2-propoxy) silane (Si(MMP)₄), tetraethoxysilane (Si(OEt)₄), tetraisocyanatosilane (Si(NCO)₄), or the like, for example, and purging is then performed. When the Zn-containing layer is formed, a Zn-containing layer is formed using, as a precursor, bis(6-ethyl-2,2-dimethyloctane-3,5-dicarboxylic acid) zinc (Zn(EDMDD)₂), bis (2,4-octanedionato) zinc (Zn(OD) 2), or the like, for example, and purging is then performed. The Zn₂SiO₄ layer may be formed by repeating formation of these auxiliary layers until having a desired thickness such as 0.1 μm or more and 2.0 μm or less, preferably followed by annealing it at a temperature of 400° C. or higher. These auxiliary layers may be formed also by repeating formation of the Zn-containing layer and formation of the Si-containing layer at a ratio of 2:1.

The method of forming the Zn₂SiO₄ layer using ALD as described above forms the Zn₂SiO₄ layer also at the interface with ceramic body 11, thereby fixing ceramic body 11 firmly to high-resistance layer 13.

### Third Step

In the third step, external electrode 14 is formed by applying an external electrode paste onto a part of a surface of high-resistance layer 13 formed in the second step so as to be connected to internal electrode 12, followed by firing. The external electrode paste may be prepared by mixing, for example, a metal component containing Ag powder, AgPd powder, or AgPt powder, a glass component containing Bi₂O₃, SiO₂, or B₂O₃, and a solvent. As the external electrode paste, a paste containing Ag as a main component and a resin component may be used. Examples of a method of applying the external electrode paste include immersion and printing. A firing temperature is, for example, 700° C. or higher and 800° C. or lower.

### Fourth Step

The method of producing multilayer varistor 1 may further include, as a fourth step, a step of forming a plated electrode. In the fourth step, the plated electrode is formed on at least a part of a surface of external electrode 14, that is, the plated electrode is formed so as to cover a part of external electrode 14. Examples of the method of forming the plated electrode include a method in which Ni plating and Sn plating are sequentially performed by an electrolytic plating method.

### Second Exemplary Embodiment

A method of producing multilayer varistor 1A according to the second embodiment includes a first step, a second step, a step of forming an intermediate layer after the first step and before the second step, and a third step described below. In the production method according to the second embodiment, high-resistance layer 13 contains Zn₂SiO₄ and bismuth oxide.

### First Step

The first step according to the second embodiment is identical to the first step according to the first embodiment.

### Intermediate Layer Forming Step

In the intermediate layer forming step, intermediate layer 15 is formed on a surface of ceramic body 11. Intermediate layer 15 may be one layer or a plurality of layers. Intermediate layer 15 may formed to contact ceramic body 11 or formed via another layer contacting ceramic body 11.

In the intermediate layer forming step, intermediate layer 15 is preferably formed by atomic layer deposition (ALD). Intermediate layer 15 formed by atomic layer deposition allows multilayer varistor 1A with enhanced moisture resistance reliability to be produced more simply and reliably.

In ALD, an SiO₂ layer is formed by using, as a precursor, Si (MMP) 4, for example, and irradiating same with O₂ plasma, and an Al₂O₃ layer is formed by using, as a precursor, trimethylaluminum, for example, and irradiating same with O₂ plasma.

Intermediate layer 15 may be formed by applying slurry containing precursor substance for each layer to be formed and subjecting it to heat treatment, for example.

### Second Step

In the second step, high-resistance layer 13 containing Zn₂SiO₄ and bismuth oxide is formed on a surface of intermediate layer 15 formed in the intermediate layer forming step.

In the second step of the second embodiment, high-resistance layer 13 containing Zn₂SiO₄ and Bi oxide may be formed by, e.g., applying a mixture of ZnO, SiO₂, and Bi₂O₃, followed by heat treatment at a temperature of 800° C. or higher.

High-resistance layer 13 may be formed using atomic layer deposition (ALD). That is, high-resistance layer 13 containing Zn₂SiO₄ and Bi oxide may be formed by forming a ZnO layer, an SiO₂ layer, and a Bi₂O₃ layer on the surface of intermediate layer 15 by ALD so that the ZnO layer, the SiO₂ layer, and the Bi₂O₃ are laminated, followed by heat treatment at a temperature of 800° C. or higher. In formation of the ZnO layer by ALD, Zn (EDMDD) 2 or the like is used as a precursor and oxidized through irradiation of O₂ plasma or introduction of H₂O or O₂ gas.

### Third Step, Fourth Step

The third step and the fourth step according to the second embodiment are identical to the third step and the fourth step according to the first embodiment.

In the manner described above, multilayer varistor 1 with enhanced moisture resistance reliability may be simply and reliably produced by forming a Zn₂SiO₄-containing high-resistance layer on a surface of a Pr-containing body by the method of producing multilayer varistor 1A of the present embodiments.

### CONCLUSION

As is clear from the above embodiments, the present disclosure includes the following aspects. In the following description, reference numerals are provided in parentheses only to clarify the correspondence with the embodiments.

A multilayer varistor (1, 1A) according to a first aspect includes a ceramic body (11), an internal electrode (12) disposed inside the ceramic body (11), a high-resistance layer (13) disposed on a surface of the ceramic body (11), and an external electrode (14) disposed on a part of a surface of the high-resistance layer (13) and connected to the internal electrode (12). The ceramic body (11) contains zinc oxide and praseodymium oxide, and does not contain bismuth oxide. The high-resistance layer (13) contains Zn₂SiO₄.

According to the first aspect, the multilayer varistor (1, 1A) have high moisture resistance reliability due to the Zn₂SiO₄-containing high-resistance layer on a surface of the Pr-containing body.

In a multilayer varistor (1, 1A) according to a second aspect, the high-resistance layer (13) contacts the ceramic body (11) and does not contain bismuth oxide in the first aspect.

According to the second aspect, the Zn₂SiO₄-containing high-resistance layer (13) may be formed even when the high-resistance layer (13) contacts the ceramic body (11), and this configuration enhances moisture resistance reliability of the multilayer varistor (1, 1A).

A multilayer varistor (1A) according to a third aspect further includes an intermediate layer (15) disposed between the ceramic body (11) and the high-resistance layer (13) in the first or second aspect. The high-resistance layer (13) contains bismuth oxide.

According to the third aspect, the intermediate layer (15) forms the Zn₂SiO₄-containing high-resistance layer (13), and enhances moisture resistance reliability of the multilayer varistor (1A).

A method of producing a multilayer varistor (1, 1A) according to a fourth aspect includes a first step, a second step, and a third step. In the first step, a ceramic body (11) having an internal electrode (12) inside thereof is prepared. In the second step, a high-resistance layer (13) is formed on a surface of the ceramic body (11). In the third step, an external electrode (14) is formed on a part of a surface of the high-resistance layer (13) such that the external electrode (14) is connected to the internal electrode (12). The ceramic body (11) contains zinc oxide and praseodymium oxide, and does not contain bismuth oxide. The high-resistance layer (13) contains Zn₂SiO₄.

According to the fourth aspect, a multilayer varistor (1, 1A) with enhanced moisture resistance reliability is simply and reliably produced by forming the Zn₂SiO₄-containing high-resistance layer on a surface of the Pr-containing body.

In a method of producing a multilayer varistor (1, 1A) according to a fifth aspect, the high-resistance layer (13) does not contain bismuth oxide in the fourth aspect. In the second step, the high-resistance layer (13) is formed by atomic layer deposition.

According to the fifth aspect, a multilayer varistor (1, 1A) with enhanced moisture resistance reliability is more simply and reliably produced by forming the high-resistance layer (13) by atomic layer deposition.

In a method of producing a multilayer varistor (1A) according to a sixth aspect, a step of forming an intermediate layer (15) by atomic layer deposition is further included after the first step and before the second step in the fourth or fifth aspect. The high-resistance layer (13) contains bismuth oxide.

According to the sixth aspect, a multilayer varistor (1A) with enhanced moisture resistance reliability is simply and reliably produced by forming the intermediate layer (15) by atomic layer deposition.

What is claimed is:

1. A multilayer varistor comprising:
a ceramic body;
an internal electrode disposed inside the ceramic body;
a high-resistance layer disposed on a surface of the ceramic body; and
an external electrode disposed on a part of a surface of the high-resistance layer, the external electrode being connected to the internal electrode, wherein
the ceramic body contains zinc oxide and praseodymium oxide, and does not contain bismuth oxide, and
the high-resistance layer contains Zn₂SiO₄.

2. The multilayer varistor according to claim 1, wherein the high-resistance layer contacts the ceramic body and does not contain bismuth oxide.

3. The multilayer varistor according to claim 1, further comprising
an intermediate layer disposed between the ceramic body and the high-resistance layer, wherein
the high-resistance layer contains bismuth oxide.

4. A method of producing a multilayer varistor, comprising:
preparing a ceramic body and an internal electrode disposed inside the ceramic body;
forming a high-resistance layer on a surface of the ceramic body; and
forming an external electrode on a part of a surface of the high-resistance layer, the external electrode being connected to the internal electrode, wherein
the ceramic body contains zinc oxide and praseodymium oxide, and does not contain bismuth oxide, and
the high-resistance layer contains Zn₂SiO₄.

5. The method according to claim 4, wherein
the high-resistance layer does not contain bismuth oxide,
said forming the high-resistance layer comprises forming the high-resistance layer on the surface of the ceramic body by atomic layer deposition.

6. The method according to claim 4, further comprising
forming an intermediate layer by atomic layer deposition after said preparing the ceramic body and before said forming the high-resistance layer, wherein
the high-resistance layer contains bismuth oxide.
